(19) United States
(12) Patent Application Publication
(10) Pub. No.: US 2025/0129888 A1
(43) Pub. Date: Apr. 24, 2025

(54) A HYDROGEN REFUELING STATION WITH LIQUID HYDROGEN SUPPLY

(71) Applicant: Nel Hydrogen A/S, Herning (DK)

(72) Inventor: Leif Kappel PETERSEN, Lem St (DK)

(21) Appl. No.: 18/691,554

(22) PCT Filed: Sep. 16, 2022
(86) PCT No.: PCT/DK2022/050190

§ 371 Date: Mar. 13, 2024

(30) Foreign Application Priority Data
Sep. 16, 2021 (DK) PA 2021 70455

(51) Int. Cl. F17C 5/06

(52) U.S. Cl. CPC F17C 5/06; F17C 2221/012; F17C 2227/0302

(57) ABSTRACT

A hydrogen refueling station including a number of heaters, an ejector with a first ejector inlet, a second ejector inlet, and an ejector outlet, a storage tank fluidly connectable to the first and second ejector inlets via the heaters and configured to store liquid hydrogen, where valves are configured to control a flow of the liquid hydrogen in conduits between the storage tank and the heaters and gaseous hydrogen in conduits between the heaters and at least one ejector, and where the ejector is configured to receive gaseous hydrogen from at least a first of the plurality of heaters and to simultaneously evacuate gaseous hydrogen from at least a second heater of the plurality of heaters via the second ejector inlet.

### TECHNICAL FIELD

The disclosure relates to a hydrogen refueling station comprising a liquid hydrogen supply and to a method for fueling a vehicle with said hydrogen refueling station.

### BACKGROUND

Known hydrogen refueling stations are highly dependent on large compressors for moving hydrogen between station components, for refueling and for pressurizing hydrogen. Such large compressors are disturbingly noisy, requires a lot of on-site energy, and they are inefficient. Moreover, known hydrogen refueling stations utilize a supply of compressed gaseous hydrogen, which has a low energy-per-unit-weight.

### BRIEF SUMMARY

The disclosure relates to a hydrogen refueling station comprising: a plurality of heaters; at least one ejector comprising a first ejector inlet, a second ejector inlet, and an ejector outlet; a hydrogen storage tank fluidly connectable to said first ejector inlet and said second ejector inlet via said plurality of heaters, and configured to store liquid hydrogen; valves configured to control a flow of said liquid hydrogen in conduits between said hydrogen storage tank and said plurality of heaters and gaseous hydrogen in conduits between said plurality of heaters and said at least one ejector; and wherein said at least one ejector is configured to receive gaseous hydrogen from at least a first of said plurality of heaters and to simultaneously evacuate gaseous hydrogen from at least a second heater of said plurality of heaters via said second ejector inlet.

This is advantageous in that it has the effect that it reduced the need for high pressure compressors at the fueling station and thereby a reduction of both OPEX and CAPEX is obtained as well as a reduction in footprint and noise is obtained. The hydrogen refueling station advantageously utilizes a supply of liquid hydrogen, which is advantageous in that liquid hydrogen has a large energy-per-unit-weight compared to compressed gaseous hydrogen. Thereby, it is possible to transport large amounts of energy per mass of hydrogen to the hydrogen station, and further it is possible to store large amounts of energy per mass of hydrogen in the hydrogen storage tank of the hydrogen refueling station. This is particularly clear when compared to traditional hydrogen storages configured for storing gaseous hydrogen.

The hydrogen refueling station is further advantageous in that it utilizes heaters for heating and thereby pressurizing hydrogen, and an ejector for evacuating gaseous hydrogen from the heaters. This is advantageous in that the process of heating and evacuation is relatively quiet, and thereby does not disturb the surroundings, including e.g., persons and/or animals, with high noise levels, which is a problem when using large compressors of traditional refueling stations.

Also, advantageously the heaters produce gaseous hydrogen from the liquid hydrogen supply, and thereby the hydrogen refueling station of the disclosure advantageously may utilize known dispensers to fuel vehicle tanks configured to receive gaseous hydrogen.

In the present context, a heater (also referred to as an evaporator) should be understood as any means suitable for storing liquid and/or gaseous hydrogen and further suitable for facilitating phase shift from liquid to gaseous hydrogen. The heater should be able to withstand a pressure of at least e.g., 755 bar, but preferably the heaters should be able to withstand even higher pressures, in order to comply with the pressure rise that occur when the heater heats the hydrogen comprised by the heater. Since the heater may in some embodiments facilitate pressures of as much e.g., as 2200 bar or higher, the heater should in these embodiments be constructed such that it is capable of complying with such pressures plus an additional buffer pressure, to ensure safe operation of the hydrogen refueling station of the disclosure. The phase shift is mainly facilitated by heating of the heater and thereby of the hydrogen stored therein. According to the disclosure, heating of hydrogen may thus be done in several ways and may e.g., comprise conductive heat transfer, convective heat transfer, radiation (e.g., electromagnetic waves), evaporation (using e.g., one or more evaporators) etc. Advantageously, heating hydrogen has the effect of increasing the internal energy of hydrogen. According to the disclosure, this energy may advantageously be utilized to fuel a vehicle tank of a vehicle and/or to fill a tank with hydrogen.

In the present context, evacuating gaseous hydrogen from a heater should be understood as the process of removing or guiding gaseous hydrogen from the heater into a conduit and further on into an ejector.

Controlling a flow refers to any form of control of flow. Flow of hydrogen in the conduits may e.g., be controlled by opening of on/off valves, to enable flow through that valve or by closing of an on/off valve to shut of flow through that valve. Flow may also be controlled by flow regulating valves, which are able to regulate the mass flow of a medium flowing through the valve. Other types of flow regulating valves may comprise pressure regulating valves. In addition, flow may also be controlled or established by pressure differences in the conduit system such as between pressure in a heater and the second inlet of an ejector.

According to an embodiment of the disclosure, said plurality of heaters are configured to isochoric heating of liquid hydrogen.

This is advantageous in that it has the effect of increasing the pressure proportionally to the temperature of hydrogen, rendering the process of utilizing the heat energy to pressurize hydrogen in the heater efficient.

It should be understood that isochor heating refers to heating of a substance, such as a fluid, without that substance changing volume. To facilitate the isochor heating process, the heaters may e.g. be build such that it does not substantially changes its internal volume. This advantageously ensures that hydrogen contained by the heater may not in principle change its volume. To further facilitate isochor heating, the interior of the heater, which is configured to contain hydrogen, may preferably be substantially completely filled with hydrogen before heating is initiated, to ensure there is no additional dead volume inside the heater. In the present context, dead volume should be understood as a volume inside the heater that is not filled with hydrogen.

According to an embodiment of the disclosure, at least one heater of said plurality of heaters are configured to heat said hydrogen based on heat transfer from a surrounding of said at least one heater to said heater.

Advantageously, this has the effect that no further energy needs to be supplied to heat and thereby pressurize the hydrogen, advantageously rendering this way of pressurizing hydrogen energy efficient.

In the present context, surroundings of a heater should be understood as the surroundings that surround the heater. The surroundings would typically be air, such as atmospheric air, however, the surroundings may also comprise e.g., other station components, such as e.g., heaters. Heat transfer may in this context refer to any one or more of heat transfer mechanisms including e.g. conduction, convection, radiation, and evaporation.

In an optional implementation of the disclosure, the heat transfer from the surroundings of the heater to the heater may involve direct heat transfer from the surroundings to the heater via convective heat transfer. In an optional implementation of the disclosure, at least one heater of said plurality of heaters may comprise a heat sink. This advantageously has the effect that it increases the heat transfer from the surroundings of the heater to the heater, and thereby reduces the time it takes to heat the hydrogen comprised by the heater. The heater may further comprise a ventilator such as e.g., a fan configured to increase the flow of air passing the heater, and preferably passing the heatsink of the heater. Advantageously, this has the effect of further increasing the heat transfer to the heater.

According to an embodiment of the disclosure, at least one heater of said plurality of heaters are configured to heat said hydrogen based on indirect heat transfer from a surrounding of said at least one heater to said heater via a medium.

Advantageously, this has the effect that the indirect heat transfer from the surroundings to the hydrogen comprised by the heater may be controlled to given requirements e.g., a given pressure in the heater required for e.g., fueling, and/or, the heating of the heater may further be controlled taking into account e.g., the temperature of the surroundings, which is advantageous. Another advantage of indirect heating via a medium, is the ability to transfer heat from specific surroundings, including e.g., other components of the station, to the heater. This could e.g., include a second heater, which has previously been heated, and thereby is warmer than the heater. Also, a further advantage is that the second heater is thus cooled when heat is transferred from the second heater indirectly to the heater.

In the present context, indirect heat transfer should be understood as transfer of heat from an object and/or fluid and to another object and/or fluid, via a medium, which may be a refrigerant. Suitable refrigerants may e.g., include neon, helium, nitrogen, and hydrogen. Note that heat may also be provided by means of electric energy i.e., electric heating.

According to an embodiment of the disclosure, at least one heater of said plurality of heaters is an evaporator.

In an exemplary implementation of the disclosure, the heater may be of one of the types of heaters including e.g., a flanged heater, circulation heater, over-the-side-heater, screw plug heater. Also, other types of heaters can be utilized, depending on the implementation of the disclosure. To comply with the low temperatures of liquid hydrogen, the heaters may preferably be made of austenitic stainless steel. This material is also well suited for maintaining strength when the pressure in the heater increases.

According to an embodiment of the disclosure, the hydrogen refueling station comprises a temperature management system, comprising a controller and a temperature sensor.

In a simple form, the temperature management system comprises a controller, temperature sensor and a fan. Based on the measured temperature, the controller controls the fan to provide a cooling air flow over the heater/heat sinks of the heater. In a more advanced version, the temperature management system can circulate cooling/heating media among any heaters of the station thereby facilitating heating those that needs to be heated and cooling those that needs to be cooled.

According to an embodiment of the disclosure, said temperature management system further comprises conduits thermally connecting said plurality of heaters enabling transfer of heat among said plurality of heaters.

It should be mentioned, that transfer of heat should be understood as both including heating or cooling. Transfer of heat away from a heater would decrease the temperature of the heater i.e., cool the heater whereas transfer of heat to a heater would increase the temperature of that heater i.e., warm the heater. A temperature management system interconnecting the heaters is advantageous in that the heat generated (cold removed) by boiling off the very cold liquid hydrogen can be used to regulate temperature of another heater. In this way the energy used to make the liquid hydrogen remote from the hydrogen refueling station can be reused so to speak by the temperature management system

According to an embodiment of the disclosure, said temperature management system is configured to heat at least one heater of said plurality of heaters by transferring heat from a heater of said plurality of heaters that has a temperature, which is higher than the temperature of said at least one heater.

According to an embodiment of the disclosure, said temperature management system is configured to cool at least one heater of said plurality of heaters by transferring cold from a heater of said plurality of heaters that has a temperature, which is lower than the temperature of said at least one heater.

According to an embodiment of the disclosure, the temperature management system is configured for cooling one of said plurality of heaters before said one heater is filled with liquid hydrogen.

According to an embodiment of the disclosure, said one heater is cooled to a predefined temperature before liquid hydrogen is allowed to enter said one heater.

Advantageously, this has the effect that the majority of the liquid hydrogen supplied to the cooled heater remains in its liquid state as it enters the heater, instead of changing immediately into gaseous state. This is advantageous, since the liquid form takes up less space in the heater since it has a much lower density compared to gaseous hydrogen. Thereby, cooling the heater to the predefined threshold enables the heater to contain a larger amount of hydrogen, which may be pressurized by heating.

The predefined threshold should be within the range of minus 200 degrees Celsius to minus 260 degrees Celsius, and preferably minus 240 degrees Celsius. Thus, prior to heating of the hydrogen contained in the cooled heater, the hydrogen should preferably have a temperature within the range of minus 250 degrees Celsius to minus 240 degrees Celsius and preferably minus 253 degrees Celsius or colder.

According to an embodiment of the disclosure, a geometry of said at least one ejector is based on an optimization of the ratio of a mass flow rate at said first ejector inlet and a mass flow rate at said second ejector inlet of said ejector for a predefined ejector inlet pressure.

According to an embodiment of the disclosure, a geometry of said at least one ejector is optimized to ejector efficiency at a predefined ejector inlet pressure.

It should be understood that ejector efficiency may here be defined as the ratio between the actual recovered compression energy, and the available theoretical energy in the fluid entering the first ejector inlet.

According to an embodiment of the disclosure, a geometry of said at least one ejector is optimize to compression ratio of the ejector for a predefined ejector inlet pressure.

The compression ratio of the ejector may here be understood as the ratio between the static pressure at the exit of the ejector diffuser divided by the static pressure at the secondary inlet of the diffuser.

According to an embodiment of the disclosure, said hydrogen refueling station comprises an array of ejectors.

In the present context, an array of ejectors should be understood as comprising at least two ejectors.

According to an embodiment of the disclosure, the ejectors of said array of ejectors has a different internal geometry.

According to an embodiment of the disclosure, said at least one ejector has variable internal geometry.

The internal geometry of the ejector can be regulated automatically to optimize a suction pressure in the second ejector inlet of the ejector. The internal geometry can be regulated e.g., by a variable throat having the effect that the ejector is able to regulate the mass flow of hydrogen through the ejector, and thereby the ejector is indirectly capable of adjusting the suction pressure at the secondary ejector inlet of the ejector and thereby capable of regulating the supply of hydrogen from the ejector to the downstream side of the ejector. Thereby, the ejector may adjust its delivery of hydrogen downstream the ejector according to different operational scenarios of the hydrogen refueling station, e.g., fueling of vehicle tanks of different pressures etc.

According to an embodiment of the disclosure, said variable geometry of said one or more ejectors with variable geometry is regulated based on a pressure determined downstream said ejector outlet.

The variable geometry may be regulated based on a required fueling pressure and/or based on a pressure required to fill a buffer tank positioned downstream the at least one ejector. A pressure determined downstream the ejector outlet of an ejector may thus e.g., comprise the pressure in the tank of a vehicle coupled to a dispenser of the refueling station, and/or it may further include pressure in the buffer tank. the geometry may also be regulated based on input related to pressure in receiving vessel, primary and secondary heaters, etc.

According to an embodiment of the disclosure, said variable geometry of said at least one ejector is automatically regulated to achieve a ramp rate target pressure.

According to an embodiment of the disclosure, said hydrogen storage tank is a cryogenic storage tank.

According to an embodiment of the disclosure, wherein said second ejector inlet of an ejector of said plurality of ejectors is connectable to an upper inlet of said hydrogen storage tank.

Advantageously, this has the effect that the suction pressure at the second ejector inlet of the ejector may be utilized to draw gaseous hydrogen from the top of the hydrogen storage tank and provide it to a downstream side of the ejector, where it may e.g., be utilized for fueling of e.g., a vehicle tank of a vehicle, via a dispenser.

According to an embodiment of the disclosure, the hydrogen refueling station comprises a compressor fluidly connected to a hydrogen buffer tank and/or comprises a compressor fluidly connected to the hydrogen storage tank and/or comprises a compressor fluidly connected to at least one ejector outlet of said plurality of ejectors.

This is advantageous in that e.g., gaseous hydrogen may be evacuated from e.g., one or more heaters to be stored in the hydrogen buffer tank. The gaseous hydrogen stored in the buffer tank can then advantageously be utilized for fueling one or more vehicles.

In some embodiments the compressor may be configured to lower the pressure in the hydrogen storage tank, e.g., by removing gaseous hydrogen from the storage tank.

Advantageously, this has the effect that the temperature in the hydrogen storage tank may be reduced by removing gaseous hydrogen from the upper portion of the hydrogen storage tank via an outlet positioned at the top end of the hydrogen storage tank, using the compressor. In particular, removing the gaseous hydrogen from the hydrogen storage tank lowers the pressure in the tank, causing the liquid hydrogen inside the hydrogen storage tank to boil and thereby the temperature of the hydrogen in the tank is reduced due to the energy required for the boiling. This may be particularly useful when the heaters and ejectors is not active and therefore the suction pressure provided by ejectors cannot be utilized for this. This may occur e.g., during low utility periods where the station is not fueling many vehicles.

According to an embodiment of the disclosure, the hydrogen refueling station comprises a compressor connected to at least one ejector outlet of said plurality of ejectors.

Advantageously, this has the effect that if none of the heaters and thereby ejectors are capable of delivering a usable fueling pressure, the compressor may provide the required fueling pressure. Furthermore, the compressor at the same time lowers the pressure downstream the at least one ejector, in turn increasing the mass flow through the ejector via the first ejector inlet, and causing an increased suction pressure in the second ejector inlet of the ejector, which advantageously may be utilized, e.g., for evacuating a heater etc.

According to an embodiment of the disclosure, gaseous hydrogen received at said first ejector inlet of said at least one ejector and gaseous hydrogen received at said second ejector inlet of said at least one ejector is provided to a receiving vessel of a vehicle connected to a dispenser of said hydrogen refueling station via said ejector outlet of said ejector.

This is advantageous in that it has the effect that both hydrogen from a pressurized heater connected to the ejector inlet, and gaseous hydrogen that is evacuated from another heater via the second ejector inlet may be provided via the ejector outlet to fuel a vehicle vessel connected to a dispenser of the hydrogen refueling station. Thereby, leftover gaseous hydrogen from the second heater does not need to be vented but may be efficiently used for fueling. Notice that hydrogen from both the two mentioned ejector inlets are mixed in the ejector and provided at the ejector outlet.

The disclosure further relates to a method of filling a receiving vessel with hydrogen gas, said method comprises the steps of: establishing a flow of liquid hydrogen from a storage tank to a first heater, receiving the liquid hydrogen in a fixed volume, increase pressure in said first heater by establish a phase shift from liquid hydrogen to gaseous hydrogen in said first heater, decrease pressure in said first heater by allowing hydrogen in gaseous state to flow from said first heater to a first inlet of an ejector, allow flow of gaseous hydrogen from a hydrogen supply to a second inlet of said ejector, wherein said flow is created by the flow of gaseous hydrogen entering said first inlet, and guide the flow of gaseous hydrogen, mixed from said first and second inlets of said ejector, from an outlet of said ejector to a receiving vessel.

The method is advantageous in that it eliminates the need for a compressor and a cooling system in the hydrogen refueling station that need to supply gaseous hydrogen at a temperature between minus 30 degrees Celsius and minus 40 degrees Celsius to a receiving vessel. Thereby is a reduction of both price, footprint, noise, and expenses to operation of the hydrogen refueling station obtained.

It should be understood that said hydrogen supply may comprise hydrogen from any one or more hydrogen storage tanks, however, it may further comprise gaseous hydrogen from e.g., any sone or more heaters.

According to an embodiment of the disclosure, the method further comprises the step of terminating flow from said outlet when a target pressure in the receiving vessel is reached.

Typically, the target pressure is predetermined and for a heavy-duty vehicle 350 bar and for a light-duty vehicle 750 bar. However, it could be any desired pressure lower than the pressure in the heaters. The pressure in the receiving vessel is provided to the controller controlling the refueling either from a pressure sensor in the receiving vessel or located in the flow path from the ejector to the nozzle.

According to an embodiment of the disclosure, the method further comprises the step of controlling pressure out of ejector by adjusting the geometry of the ejector.

The pressure and thereby flow can be regulated based on input related to pressure in heaters, buffer tanks and/or the receiving vessel.

According to an embodiment of the disclosure, the method further comprises the step of allowing a user to initiate the step of decreasing pressure in said first heater.

The user preferably communicates with the hydrogen refueling station via a display of a user interface. The user interface may be a display of a dispenser of the hydrogen refueling station or remote e.g., on a smartphone communicating with the hydrogen refueling station either directly or indirectly vis a central server

According to an embodiment of the disclosure, said flow of liquid hydrogen to said second heater is stopped when said second heater is at least 90% full, preferably at least 95% full, most preferably at least 98% full.

According to an embodiment of the disclosure, said fixed volume of said first heater and/or of a second heater is defined by a volume of said first heater and/or by a volume of said second heater, respectively, or by a volume between two valves located in conduits on each side of said first heater and/or said second heater, respectively.

The second heater (and the first heater) define a fixed interior volume which can comprise liquid and/or gaseous fluid. Alternative, the valves in the conduits on each side (upstream and downstream) of the heater may define the volume. In this alternative, some of the volume of the conduits may also be part of the fixed volume.

According to an embodiment of the disclosure, said phase shift is established by heating said first heater.

The heater (volume comprising the liquid gas) can either be heated passive by the ambient temperature which in most situations is higher than the temperature of the liquid hydrogen. Alternative, a fan can blow hot air towards the heater, a temperature management system can be connected to the heater and thereby circulate a medium. The circulated medium is preferably a medium that can be used either to heat or cool the heater.

According to an embodiment of the invention, the method further comprises the step of pre-cooling of said first and/or second heaters.

This is advantageous in that it has the effect of cooling the heater reduces the temperature difference between the heater and the liquid hydrogen and thereby the intensity of the boil off of the liquid hydrogen is reduced.

According to an embodiment of the disclosure, the hydrogen supply is said second heater, a buffer tank or said hydrogen storage tank.

According to an embodiment of the disclosure, the method further comprises the step of allowing flow of liquid hydrogen to said second heater simultaneously with gaseous hydrogen leaving said second heater, wherein the flow of liquid hydrogen to said second heater is facilitated by the flow of gaseous hydrogen leaving said second heater.

According to an embodiment of the disclosure, said receiving vessel is a vehicle tank.

According to an embodiment of the disclosure, said vehicle tank is supplied with gaseous hydrogen from a heater, of a plurality of heaters, having the lowest usable fueling pressure.

This is advantageous in that heaters with high pressure are saved for fueling stages where the vehicle tank is closer to the target pressure than at the beginning of a refueling. A lowest usable fueling pressure may be considered a pressure that is between 5% to 1000% above the vehicle tank pressure. Thus, depending on the particular implementation of the disclosure, the usable pressure may vary. Advantageously, by utilizing a usable fueling pressure that is well above the vehicle tank pressure of the vehicle that is connected to the dispenser of the station and should be fueled, the need to switch to heaters with a larger pressure during fueling may be reduced.

According to an embodiment of the disclosure, said vehicle tank may be first supplied with gaseous hydrogen from a first heater of a plurality of heaters, the first heater having a lowest usable initial fueling pressure of fueling pressures of said plurality of heaters, and subsequently when a fueling pressure of said first heater exceeds a predefined threshold whereat said fueling pressure is no longer useable for fueling said vehicle tank, said vehicle tank is supplied with gaseous hydrogen from a second heater, of said plurality of heaters, having a higher usable initial fueling pressure than said first heater.

This is advantageous, in that when the first heater does no longer provide a usable fueling pressure, the vehicle tank may be fueled from a second heater.

The usable initial fueling pressure should be understood as a fueling pressure provided by a heater at the initiation of fueling of a vehicle tank from that heater, and wherein the usable initial fueling pressure is suitable for fueling a vehicle tank. After initiating the fueling the fueling pressure will drop from the initial fueling pressure. Further details on fueling pressures and usable fueling pressures are given in the description below.

According to an embodiment of the disclosure, a hydrogen refueling station is operated according to the above-described method of filling a receiving vessel with hydrogen gas.

According to an embodiment of the disclosure, the method further comprises the steps of: establishing a flow of liquid hydrogen from a storage tank (6) to a second heater (2b), receiving said liquid hydrogen in a fixed volume of said second heater; terminating said flow from said first heater (2a) to said first inlet (4) of said ejector (3), when a fueling pressure drops below a predefined threshold; increase a pressure in a second heater (2b) by heating said liquid hydrogen received in a fixed volume of said second heater by said second heater (2b); decrease pressure in said second heater (2b) by allowing hydrogen in gaseous state to flow from said second heater (2b) to said first inlet (4) of said ejector (3); evacuate gaseous hydrogen from said first heater 2a by establishing a flow of hydrogen from an outlet of said first heater 2a to said second inlet (5) of said ejector (3), wherein said flow is established by said flow of gaseous hydrogen from said second heater (2b) to said first inlet (4) of said ejector (3); and guide said flow of gaseous hydrogen, mixed from said first and second inlets (4, 5) of said ejector (3), from an outlet (9) of said ejector (3) to a receiving vessel.

This is advantageous in that by having a second heater, fueling of a vessel connected to the hydrogen refueling station may be continued using the second heater if the pressure delivered by the first heater exceeds a predefined threshold. The predefined threshold may refer to a fueling pressure, such as a usable fueling pressure. E.g. if the fueling pressure drops below the pressure in the vessel, it is not possible to fuel the vessel with the heater and thereby the fueling pressure is no longer usable. A usable pressure may be defined as a pressure above the pressure in the vessel. Other predefined threshold associated with fueling pressure are described elsewhere in the description.

Furthermore, a hydrogen station according to the disclosure, having a second heater is also advantageous in that the second heater may be utilized to evacuate gaseous hydrogen from the first ejector, and thereby the first ejector can be filled with additional liquid hydrogen. Also, advantageously, the first heater may similarly in some embodiments be used to evacuate gaseous hydrogen from the second heater.

Various embodiments of the disclosure and various optional features of the disclosure have been described in relation to the figures. It should be understood that any feature and any optional feature of any of the described embodiment may advantageously be combined depending on the given implementation of the disclosure. Thus, more advanced embodiments of the disclosure such as e.g., the embodiment described in relation to FIG. 4, may be implemented with e.g., the embodiment described in relation to FIG. 1. E.g., the compressor 18, the backflow line 17, and the buffer tank 20 may e.g. be implemented with the embodiment described in relation to FIG. 1, etc.

### THE DRAWINGS

Various embodiments of the disclosure will in the following be described with reference to the drawings where:

FIG. 1 illustrates a hydrogen refueling station comprising two heaters and one ejector according to an embodiment of the disclosure,

FIG. 2 is illustrates a graphical representation of pressure changes in a heater before and during a refueling of a vehicle tank of a vehicle using a hydrogen refueling station according to an embodiment of the disclosure,

FIG. 3 illustrates a hydrogen refueling station comprising two heaters and two ejectors according to an embodiment of the disclosure,

FIG. 4 illustrates a hydrogen refueling station comprising two heaters and an array of ejectors according to an embodiment of the disclosure,

FIG. 5 illustrates an ejector with variable geometry according to an embodiment of the disclosure, and

FIG. 6 illustrates a visual representation of method steps according to an embodiment of the disclosure.

Note that similar elements on the figures may be referred to with similar wording even if these are not specified with a reference number on all figures.

### DETAILED DESCRIPTION

In the following, various embodiments of the disclosure are described with reference to the figures.

Details such as a specific method and system structures are provided to give an understanding of embodiments of the disclosure. Note that detailed descriptions of well-known systems, devices, circuits, conduits, and methods have been omitted so as to not obscure the description of the disclosure with unnecessary details. It should be understood that the disclosure is not limited to the particular examples described below, and that a person skilled in the art can also implement the disclosure in other embodiments without these specific details. As such, the disclosure may be designed and altered in a multitude of varieties within the scope of the disclosure as specified in the claims.

The present disclosure relates to a hydrogen refueling station, the main purpose of which is to supply hydrogen to a receiving vessel of a vehicle, from a hydrogen supply in the form of a supply network, external hydrogen storage, internal hydrogen storage or a temporary hydrogen storage. According to the present disclosure, the supply is a liquid hydrogen supply.

To regulate the hydrogen pressure, temperature, flow, time etc. to comply with currents standards such as e.g., the SAE J2601 standard for refueling of a light duty fuel cell vehicle with hydrogen, the hydrogen refueling station comprises a control and monitoring system and a dispenser having a nozzle connectable (at least indirectly) to a receiving vessel. Further, the refueling station may comprise compressors, cooling systems, filters, valves, electric components, etc. A hydrogen refueling station according to the present disclosure may also fill receiving vessels according to other standards or protocols. This is especially true if the receiving vessel is of a heavy-duty vehicle, train, ship, airplane, etc. Hence, filling a receiving vessel or a tank of a vehicle should not limit the disclosure to only filling a tank of a fuel cell light duty vehicle.

A refueling process involves several states, which in generic terms can including moving from a “ready state” to a “pre-refueling state” when a refueling is requested by a user. When the user has lifted the nozzle and attached it to a vehicle, the user may initiate “Refueling Start Up State” where the start pressure of the vessel of the vehicle is determined. Upon determining start pressure and other initial parameters a “Main Refueling State” is performed where hydrogen is provided to the vessel of the vehicle for the purpose of filling the vessel of the vehicle. When the refueling is completed a “Refueling Stop State” is entered where preparations for returning to the ready state is made, such as emptying hydrogen from hose and nozzle.

The control of the refueling procedure and the preparation of such refueling procedure is controlled by a control and monitoring system, which preferably includes a safety controller and a process controller.

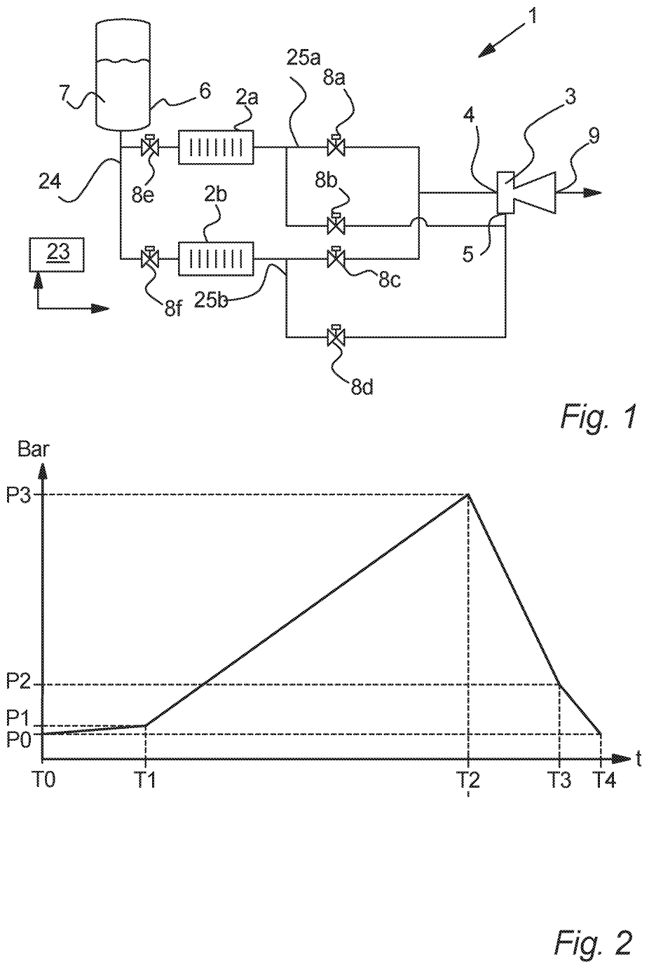

FIG. 1 schematically illustrates a hydrogen refueling station 1 according to an embodiment of the disclosure. In this exemplary embodiment, the hydrogen refueling station 1 comprises a first heater 2a and a second heater 2b, an ejector 3 with a first ejector inlet 4, a second ejector inlet 5 and an ejector outlet 9, a hydrogen storage tank 6 containing liquid hydrogen 7, and valves 8a-8f. The exact location of the valves 8a-f in the conduits may vary from the embodiment illustrated in FIG. 1. The hydrogen storage tank 6 is fluidly connectable to the first ejector inlet 4 and the second ejector inlet 5 of the ejector 3 via the heaters 2a, 2b, and the flow of hydrogen in conduits connecting the mentioned components is controlled by the valves 8a-8f via a controller 23. In this example, the valves are shut off valves also sometimes referred to as on/off valves. However, other implementations of the disclosure may optionally comprise different types of valves, e.g., pressure control valves and/or flow control valves. Additionally, to comply with the low temperatures of e.g., liquid hydrogen, at least some of the conduits that are subjected to low temperatures may comprise/be made of austenitic steel or similar, which advantageously keeps the shape and/or properties of the conduits substantially constant even at the very low temperatures of e.g., liquid hydrogen (Hydrogen is present in its liquid state at a temperature below minus 252.87° C.). Further, at least some of the conduits are isolated.

In this example, the first heater 2a is filled with liquid hydrogen from the storage tank 6 by opening of the valve 8e positioned upstream the inlet of the heater 2a and closing of the valves 8a, 8b positioned downstream the outlet of the heater 2a as well as the valve 8f positioned upstream the second heater 2b. The valves 8e, 8a, 8b are examples of valves, the number of valves can be higher or lower and preferably at least one valve on each of the upstream and downstream of the heaters 2 is located as part of the heaters 2 (maybe integrated in the heaters). Typically, the downstream outlet of the heater i.e., towards the ejector is physically located higher than the upstream inlet of the heater. This is to ensure to get the warmest gaseous hydrogen out first and to reduce risk that liquid hydrogen continues into the conduits 25.

In this example, the hydrogen storage tank 6 is positioned above the heaters 2a, 2b, with respect to the ground, and thereby, the flow of liquid hydrogen from the hydrogen storage tank 6 to the first heater 2a can be established at least partly by the force of gravity. When the first heater 2a has been filled with hydrogen, the first heater 2a can be fluidly isolated by closing the valve 8e and 8a-b. The first heater then heats and thereby pressurizes the hydrogen. This heating is done by isochor heating of the hydrogen inside the heater. This means that the volume of the hydrogen inside the heater is kept substantially constant, and thereby advantageously, the pressure inside the heater is greatly increased. The pressure increases because the average kinetic energy of the hydrogen molecules increases in proportion to the temperature increase, and thereby during heating, the faster moving particles collides with the walls of the heater more frequently and with greater force. This causes the force on the walls to increase and so the pressure increases.

Suitable heaters 2 would typically only comprise one chamber. The closer to 100% full that this chamber can be filled with liquid hydrogen, the higher the end pressure of the gaseous hydrogen in the chamber can be. As will be described, a phase shift from liquid hydrogen to gaseous hydrogen will take place in the chamber and the pressure in the chamber will increase. The phase shift may be facilitated simply by controlling temperature of the chamber and thereby the phase of the hydrogen. By increasing the temperature with 16 Kelvin from the initial liquid state, the hydrogen will achieve a so-called supercritical state. If at this point in time, the heating of the hydrogen continues, the pressure in the chamber can be increased further. As an example only, the maximum pressure in the chamber is up to 2000 bar. Nevertheless, it is possible to further increase the pressure by further heating of the hydrogen inside the heater. However, the amount of energy required to heat the hydrogen in the heater to achieve a pressure much beyond 2200 bar may typically render the process of elevating the pressure to such high pressures through heating infeasible, unless a cheap and clean energy source and/or high ambient temperatures are available and utilizable for the heating process. However, as long as no vehicle is connected to the station for fueling, the heating may continue, e.g. until the temperature of the hydrogen contained in the heater is at a temperature substantially equal to the ambient temperature.

The temperature control can be facilitated by a cooling/heating system having a heat exchanger and conduits integrated in or associated with the heater/chamber. Alternative or in addition, the cooling/heating system may comprise a fan blowing hot/cold air towards cooling/heating fins of the heater. Hence, many different types of cooling/heating systems can be used to control the temperature. Preferably, if the cooling/heating system circulates a refrigerant or cooling/heating medium, this medium must be able to be circulated at the temperature of the liquid hydrogen.

Note that due to the fact that the temperature of the heaters is typically close to or equal to ambient temperature at the start of the filling of the heater, i.e., warmer than the liquid hydrogen, the heating of the liquid hydrogen typically will start as the liquid hydrogen enters the heater. Further, as will be described below, the heaters 2 may comprise a thermal control system that can be used to control the temperature of the heater. Hence, the temperature difference between the liquid hydrogen and the heaters can be controller and thereby the speed with which e.g., the pressure rises in the heater can be controlled and e.g., the speed with which the phase shift is happening inside the heaters can be controlled.

The thermal control system may be controlled so as to reach a specific heater target pressure of the gaseous hydrogen inside the heater. In the below example, this heater target pressure is 2200 bar but could in principle be any value from 100 bar to 3000 bar (or even lower or higher) in steps of e.g., 10 bar. The heater target pressure may be optimized to the geometry of the ejector 3, such that the ejector 3 may provide an optimized suction pressure in the second ejector inlet 5 when hydrogen is flowing through the ejector at the pressure delivered by the heater. The ejector/ejector array then controls the pressure out of the ejector/ejector array to comply with the required ramp rate target pressure for a particular receiving vessel, which in most cases is a tank of a fuel cell vehicle. A heater target pressure from around 200 bar and up is considered useful, but to omit the main compressor a pressure higher than 200 bar is necessary, to be able to operate the hydrogen refueling station satisfactory.

In this particular example, as the pressure in the first heater 2a reaches a heater target pressure exemplified threshold of 2200 bar, the heating provided by the thermal control system is stopped. If no vehicle vessel is connected to a dispenser of the station, the thermal control system may keep the pressure of the heater at this exemplified 2200 bar level (threshold). When a user couples a vehicle to the dispenser of the station to fuel a vehicle vessel of the vehicle the pressurized hydrogen contained in the heater may be utilized for fueling. The fueling of the vehicle tank is initiated by the controller 23, which opens the valve 8a, causing the heated and pressurized hydrogen to flow from the heater to the ejector inlet 4, through the ejector 3 and via the ejector outlet to a receiving vessel of the vehicle. The flow of hydrogen is driven by a pressure difference between the pressure in the first heater 2a and at the downstream side of the first heater, including the ejector 3 and receiving vessel. Within the ejector 3, the velocity of the gaseous hydrogen increases as the cross sectional areal of the fluid passage inside the ejector gradually narrows, causing a pressure drop at this position in the ejector. Subsequently, towards the outlet of the ejector 3, the cross-sectional area of the fluid passage gradually increases, and thereby the velocity decreases at the outlet of the ejector and pressure is regained. Importantly, the pressure drop in the ejector causes a suction at the second ejector inlet 5 of the ejector 3. By opening the valve 8d positioned between the second heater 2b and the second ejector inlet 5 of the ejector 3, the suction is utilized to evacuate hydrogen, e.g., gaseous hydrogen, from the second heater 2b via the second ejector inlet 5. If, the valve 8f is also opened, the suction may also be used for filling the second heater 2b with hydrogen from the hydrogen storage tank 6. The evacuated hydrogen, e.g., gaseous hydrogen, leaves the ejector via the ejector outlet 9 mixed together with the hydrogen supplied from the first heater 2a.

The hydrogen leaving the ejector outlet 9 may advantageously be used for fueling a vehicle coupled to a dispenser (not shown) fluidly connected to the ejector outlet 9, and/or alternatively to fill a storage tank, which can then e.g., be used for supplying a dispenser, and thereby for filling a receiving vessel, and/or for performing pressure consolidation, etc.

As hydrogen is supplied to the ejector inlet 4 from the first heater 2a, the pressure in the first heater 2a continuously drops, and when the pressure difference between the first heater and a downstream side of the first heater reaches a prespecified threshold and/or alternatively, when the pressure in the first heater reaches a prespecified threshold, the valves 8a and 8d closes. The prespecified threshold may e.g., be determined as a pressure whereat fueling of a vehicle tank of a vehicle is no longer possible or is slowed down below a prespecified fueling rate. The prespecified threshold may also be specified according to e.g., SAE J2601-1. In some implementations of the disclosure, the prespecified threshold may be a fueling ramp rate according to e.g., SAE J2601-1. The prespecified threshold may thus be set at 1.2 MPa/min. However, fueling ramp rate tolerances may lie from between 1.2 MPA/min to 28.5 MPa/min. Therefore, the prespecified threshold can be determined within this range. If required, for example to improve fueling efficiency, the prespecified threshold can be set lower, or even higher than this range.

Above, the first step in filling a receiving vessel has been described i.e., the first heater 2a has supplied hydrogen to the first ejector inlet 4 of the ejector 3 and hydrogen has been evacuated from the second heater 2b. If valve 8f was open, the second heater 2b would have been supplied with liquid hydrogen from the storage tank 6, the liquid hydrogen change phase to e.g., gaseous hydrogen and may be further heated in the heater 2b and thereby pressurized to a maximum/threshold pressure of e.g., 2000 bar and/or 2200 bar, and possibly e.g., reach the previously mentioned supercritical state.

Because it takes a certain time to heat hydrogen contained in a heater, a reconfiguration step may optionally be implemented. The reconfiguration step takes place in the period between a step one and a step two (also referred to as a second step). In step one, a first heater is utilized to provide pressurized hydrogen to the first ejector inlet as described above, and in step two a second heater is utilized to provide pressurized hydrogen to an ejector. Because the process of pressurizing liquid hydrogen in the heater by isochor heating takes typically takes longer time than a fueling, a latent period may occur between step one and step two, wherein none of the two heaters have had the time to sufficiently pressurize hydrogen, and thereby the hydrogen station may not be able to fuel a vessel in this latent period.

To avoid the latent period wherein both heaters cannot provide pressurized hydrogen as described above, more additional heaters may optionally be implemented. E.g three heaters, such as e.g. four heaters, such as e.g. five heaters such as more than five heaters may be implemented to minimize the laten period and thereby advantageously increase the fueling capacity of the hydrogen refueling station. Thus, when the first heater has been utilized to e.g. evacuate gaseous hydrogen from the second heater, and the second heater is still pressurizing hydrogen, fueling maybe performed through a third heater that has been heated in the period where fueling has been performed utilizing the first heater. Then, when fueling has been performed utilizing the third heater, the first heater has been through its reconfiguration period where hydrogen is pressurized to a usable fueling pressure, and thereby the first heater can be used for fueling. Advantageously, this cycle of fueling and reconfiguration of heaters may be continued to enable the hydrogen refueling station to fuel without latent periods. The number and size of heaters may be optimized according to a desired fueling capacity.

Optionally, in the reconfiguration period, fueling may be performed as direct filling via one or more compressors. Connected to one or more dispensers of the hydrogen refueling station.

Optionally, cascade refueling from a buffer tank comprising gaseous hydrogen may be implemented. Cascade refueling may e.g., advantageously be utilized to fuel a vessel during the reconfiguration step and/or during latent periods.

A second step in filling the receiving vessel will now be possible to execute. To continue supplying the ejector inlet 4 with pressurized hydrogen now from the second heater 2b, the valve 8c positioned between the second heater 2b and the ejector inlet 4 is therefore opened, while the valve 8d positioned between the outlet of the second heater 2b and the second ejector inlet 5 is closed. Heated and pressurized hydrogen from the second heater 2b thereby flows through the ejector 3 via the ejector inlet 4 and outlet 5, and the pressurized hydrogen is then utilized for fueling of a vehicle, or optionally, if no vehicle is connected to a dispenser of the hydrogen refueling station, the hydrogen may instead be used to fil an optional buffer tank that may optionally be implemented and positioned downstream the ejector outlet 9 and with a shut of valve positioned to control the flow to the buffer tank. Again, a suction is created at the second ejector inlet 5 as the velocity of the hydrogen flowing through the ejector via the first ejector inlet 4 is increased causing a pressure drop inside the ejector before the velocity is decreased at the ejector outlet 5. The suction is now utilized to evacuate hydrogen, e.g., gaseous hydrogen, from the first heater and for filling of the first heater, by opening the valves 8b, while keeping the valve 8f closed.

Note that the cycle can be continued if also valve 8e is opened to fill the first heater 2a, by allowing liquid hydrogen to enter the first heater 2a. Opening the valves 8e and 8f in the two steps described above ensures that liquid hydrogen is flowing to the heaters and new hydrogen, e.g., gaseous hydrogen, is created for the continuous supply of the receiving vessel as described above.

Optionally, the suction pressure at the second ejector inlet of an ejector may also be utilized for drawing gaseous hydrogen from an optional buffer tank containing gaseous and/or liquid hydrogen. This may e.g. be advantageous when all heaters of the refueling station contain heated and pressurized hydrogen. Thereby the suction pressure may be utilized for fueling a vehicle, utilizing gaseous hydrogen contained by the buffer tank. Thus, the ejector inlet may optionally be couplable to a buffer tank. Further optionally, the ejector outlet may be couplable to the same buffer tank and/or one or more further buffer tanks, to enable filling of the buffer tank and/or the one or more further buffer tanks, with gaseous hydrogen provided from a heater via the ejector outlet.

Further optional, the fueling of the vehicle tank may be initiated by the controller 23, which opens the valve 8a and 8e (or similar for the second heater the valves 8c, 8e, and/or similar embodiments comprising additional heaters), causing heated and pressurized hydrogen contained by the heater to flow from the heater to the ejector inlet 4, through the ejector 3, and via the ejector outlet to a receiving vessel of the vehicle. Simultaneously, the suction pressure generated in the second ejector inlet 5 causes gaseous hydrogen to flow from the heater and via valve 8b to the second ejector inlet 5 of the ejector 3. Both of these flows of hydrogen are mixed in the ejector 3 and outputted via the ejector outlet. Advantageously, this has the effect that the suction pressure in the second ejector inlet may be utilized to fuel a vehicle, even without needing a second ejector and/or a buffer tank to draw hydrogen from. Notice that the described optional feature may be implemented with any one or more ejectors, according to different embodiment

In the above exemplified implementation of the disclosure, the process of heating at least partly utilizes the temperature difference between the environment surrounding the heaters (ambient temperature) and the liquid hydrogen provided to the heaters 2a, 2b, from the hydrogen storage tank 6. This is possible, since the hydrogen supplied from the hydrogen storage tank to the heaters is substantially colder than the surroundings, and in particular may be e.g., as cold as minus 254 degrees Celsius. This type of heating process may e.g., utilize direct heating via convective heat transfer, where the heaters may comprise a heat sink that is arranged to be in contact with the surroundings, e.g., air, which is warmer than the liquid hydrogen. The heat sink advantageously increases the surface area of the heater and thereby enhances the heat transfer between the surroundings and the heater. Thereby, in this implementation of the disclosure, the temperature of the heater is elevated predominantly based on convection. In this implementation, the heaters are made of a heat conductive material and thereby as the temperature of the heater elevates, the heat is transferred to the hydrogen comprised by the heater, via the heat conductive material. The heat conductive material is a heat conductive metal. As also mentioned above, the heating may also be at least partly established by a thermal control or management system, which will be described in further details below.

In an optional implementation of the disclosure, the heaters are evaporators configured to heat the hydrogen comprised by the evaporator, utilizing a suitable heat transferring medium, which does not transform into a solid state within the operating temperatures of the evaporator. Examples of such suitable heat transferring mediums are helium, hydrogen. However, other heat transferrin mediums with similar properties may optionally be applied in implementations of the disclosure. E.g., alternatively, neon or nitrogen may be used e.g., in high flow temperature management systems. Neon and nitrogen are advantageous in that these are non-flammable.

Optionally, as described above a not illustrated buffer tank may be provided downstream the ejector outlet 9. Thereby, in periods where the hydrogen refueling station is not actively fueling a vehicle, the buffer tank may be filled with gaseous hydrogen supplied from the hydrogen storage tank 6. Advantageously, this has the effect that the gaseous hydrogen stored in the buffer tank may be utilized for fueling of a vehicle when required. The buffer tank may be particularly useful for fueling a vehicle e.g., in situations where the pressure in both of the heaters is not high enough to fuel the vehicle and/or high enough to fuel the vehicle at a pre-determined flow rate.

In a further optional implementation of the disclosure, the heaters may increase the pressure to a pressure within the range of 1500 to 2500 bar, preferably to a heater target pressure i.e., as high as possible, before valves at the downstream side of the heaters are opened, to let out hydrogen from the heaters. The heating may stop when a temperature equilibrium between the hydrogen inside the heater and the surrounding environment (the ambient temperature) is reached. Since the heating of hydrogen slows down when the temperature of hydrogen inside the heater approaches the ambient temperature, the valves downstream to the heater may be opened to e.g., fuel a vehicle at a certain target pressure, and/or at a temperature of the hydrogen contained in the heater that is below the ambient temperature. This has the effect of ensuring a time-efficient heating process of the heaters, by avoiding the slow temperature ramp rate occurring at a specific temperature difference between the ambient temperature and the temperature of the heater. This temperature difference may lie within the range of 50% to 99% of the mentioned temperature equilibrium, e.g., at 90% of the temperature equilibrium. Also, if the pressure in a heater is high enough to fuel a vehicle connected to the dispensing nozzle (not shown) of the hydrogen refueling station at a sufficient ramp rate, the valves downstream the heater may be opened even if a pre-determined target pressure and/or temperature of the hydrogen in the heater is not reached.

Typically, heating of the hydrogen contained in a heater is continued until an equilibrium with the ambient temperature is reached, unless fueling of a vehicle is suddenly required at a stage before equilibrium is reached.

Heating of the hydrogen to temperatures above ambient temperature requires additional supply of energy. As previously mentioned, this is typically not feasible, however, optional embodiments of the disclosure may comprise a temperature management system capable of heating the heaters above the ambient temperature. The heater target pressure may be controlled by the temperature management system. Such heating of the heaters may e.g., be advantageous when implementing the hydrogen refueling station in cold environments.

Preferably, the opening and closing of the valves 8a-f described above, is controlled by the controller 23 in response to pressure measurements and/or temperature measurements received by the controller from pressure sensors and/or temperature sensors. The pressure and/or temperature measurements are preferably performed by pressure and/or temperature sensors located between the heaters 2 and the ejectors 3. Alternative, or in addition, the sensors may be positioned downstream the ejector 3. The exact location of the sensors in the system is chosen according to design and/or space e.g., allowing service/reading. It should be mentioned that a controller may also receive input from sensors of the vehicle.

It should be mentioned, that when heating the liquid hydrogen, the temperature of the hydrogen contained in the heater typically does not exceed the ambient temperature. Thus, during a fueling, the temperature of hydrogen remains well below e.g., 85 degrees Celsius. Thereby, the temperature advantageously stays well below temperature safety thresholds e.g., during fueling of vehicle vessel of a vehicle.

FIG. 2 shows a graphical representation of pressure changes over time in a heater of a hydrogen station according to the disclosure. Specifically, pressure changes are illustrated from the initial filling of the heater with liquid hydrogen, during the heating of the hydrogen in the heater and during fueling of a receiving vessel, such as a vehicle tank connected to a dispenser of the hydrogen refueling station of the disclosure, with hydrogen heated and pressurized with the heater.

At time T0, an inlet valve (8e, 8f in FIG. 1) at the inlet of the first heater 2a is opened to establish a flow of liquid hydrogen from a hydrogen storage tank 6 to the first heater 2a, and a valve positioned at the outlet of the heater is closed. At this time T0, the pressure P0 in the heater is approximately 1.01325 bar (˜1 Atm) as hydrogen has just been evacuated from the heater, e.g. by utilizing a suction from a second ejector inlet connected to the heater. The suction is as previously described established by a second heater 2b delivering pressurized hydrogen to the ejector. Note, that the pressure may be higher, or possibly even lower depending on the suction generated by the second heater. However, in this particular example the pressure is approximately 1. bar.

To avoid a considerable boil off when cold liquid hydrogen enters a warm heater with significant mass and correspondingly thermal inertia, the temperature management system may facilitate cooling of the heater prior to the liquid hydrogen entering the heater. Optimally, prior to filling, the heater is cooled to approximately minus 254 degrees Celsius i.e., around the temperature of liquid hydrogen, but the closer to this temperature the better and a temperature below minus 200 degrees Celsius is preferred. Again, this is because cooling of the heater advantageously greatly minimizes boiling of the liquid hydrogen entering the heater, and thereby ensures that a gaseous boil off of hydrogen does not fill up most of the volume inside the heater.

Opening a valve between the tank 6 and a first heater 2a allows flow of liquid hydrogen from the tank 6 to the first heater 2a e.g., utilizing the force of gravity, a pressure drop from the storage tank 6 to the heater 2, a pump, etc. Due to e.g., the temperature difference between the liquid hydrogen entering the first heater that has been cooled, the pressure in the heater increases from the initial pressure P0 of substantially 1 bar at a slow rate (depending on the temperature difference), until the heater/(e.g. an evaporator) is filled with hydrogen.

Then, at time T1, the valve at the inlet 8e of the first heater 2a closes so that hydrogen is isolated inside the first heater 2a. At this time the hydrogen is mainly in its liquid state, but due to the boil off that has already happened, the heater will also typically comprise some hydrogen in its gaseous state. In an embodiment, after completing filling of the first heater 2a (e.g. in this embodiment 5-15 minutes after filling of the heater was initiated), the heater starts heating the hydrogen inside first the heater 2a at time T1. If heating completing the filling of the heater, gaseous hydrogen would be produced due to the heating, disadvantageously taking up the space in thereby reducing the amount of liquid hydrogen in the heater. Ideally, heat from the surroundings of the heater is utilized for this process (also referred to as ambient heating), advantageously making the heating process energy efficient. Heating is done utilizing a temperature/thermal management system of the disclosure as described below. The isochor heating process causes a pressure increase in the heater from e.g. 3 bar P1 at time T1 to e.g. 2000 bar P3 at time T2. When the pressure reaches the 2000 bar (a value that may be predetermined) at T2 after e.g. 1-2 hours depending on the ambient temperature, the valve 8a at the outlet of the first heater 2a is opened and the heated and pressurized hydrogen is led to an ejector 3 and the high pressure is utilized through the ejector 3 to evacuate gaseous hydrogen from a second heater 2b coupled to a second inlet of the ejector 5 via valve 8d, which is opened, while valve 8b and 8c is kept closed.

In this example, this process typically takes 10-15 minutes (from time T2 to time T3). The mix of gaseous hydrogen from the two heaters 2a, 2b may, as mentioned be used to fuel one or more vehicle tanks of one or more vehicles coupled to dispensers of the station, it may be used to fill receiving buffer tanks, or other vessels connected to the outlet of the ejector. As hydrogen leaves the heater, the pressure therein gradually drops from P3 towards P2 and at time T3, where the pressure in the heater in this example lies within a range of 150-200 bar, making fueling infeasible, and the first fueling step is therefore terminated.

Thus, at this time T3, the outlet of the heater, now having a pressure (in this example) between 150 and 200 bar, is coupled to a second inlet 5 of the ejector 3. Then the ejector is supplied with hydrogen at its first inlet 4 from e.g. a second heater 2b (having a higher pressure), and the suction provided at this second ejector inlet 5 is then utilized to evacuate hydrogen from the first heater 2a having a pressure in the range between 150 bar and 200 bar, causing the pressure in the first heater 2a to drop to approximately 1. bar P0, at time T4. The pressure P0 may be even lower e.g., approximating zero bar, depending on the described suction provided by the ejector 5. A lower pressure may advantageously increase the pressure drop between the storage tank 6 and the heater prior to filling of the heater, and thereby increasing the rate with which the heater is filled with liquid hydrogen.

After evacuating the leftover gaseous hydrogen from the first heater 2a utilizing suction pressure from the second ejector inlet 5 of the ejector 3, the first heater 2a is ready to be filled with liquid hydrogen, and the described process may be repeated.

Optionally, the time required for filling of the heater with liquid hydrogen may be decreased by utilizing a pump, to pump liquid hydrogen from the storage tank into the heater.

Optionally, cooling of the heater prior to filling of the heater with liquid hydrogen, may be done using a cooling system utilizing nitrogen as a refrigerant. Advantageously, nitrogen is abundantly available in abundant amounts in atmospheric air, is cheap, and can e.g., be generated onsite or be provided from an external production site. Nitrogen may cool a heater to approximately minus 196 degrees Celsius. Subsequently, hydrogen may be utilized to provide further cooling to achieve a temperature below minus 196 degrees Celsius, while still minimizing hydrogen due to the initial cooling with nitrogen. After cooling of the heater with nitrogen, nitrogen can simply be vented to the surroundings.

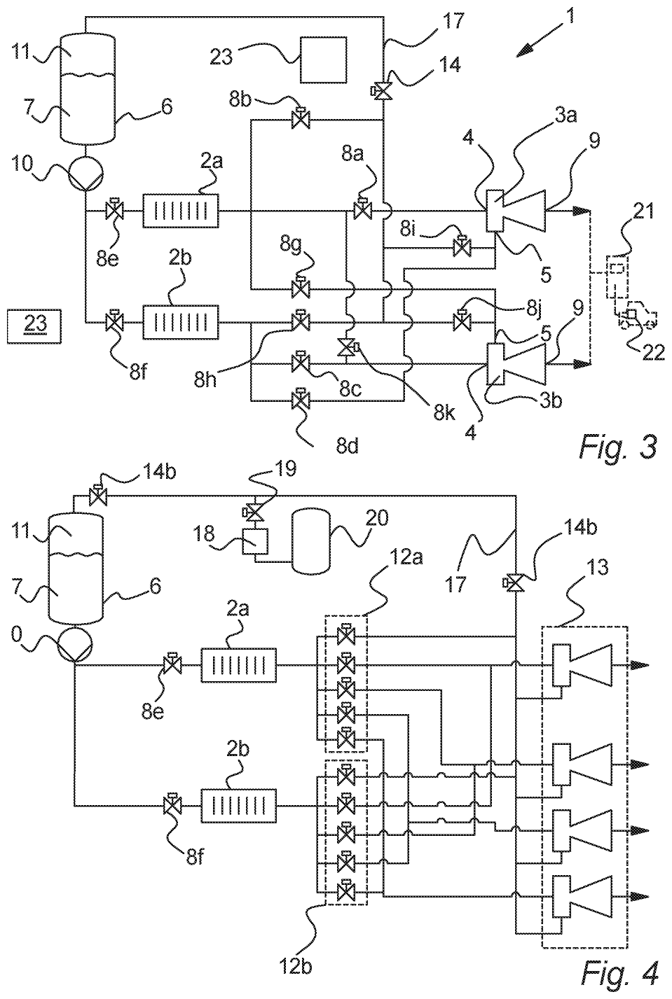

FIG. 3 shows a schematic illustration of a hydrogen refueling station according to an embodiment of the disclosure. The embodiment illustrated in FIG. 3 extends the embodiment shown in FIG. 1 by including an additional ejector, two in total 3a, 3b, as well a backflow line 17 coupling the downstream side of the heaters 2a, 2b to the hydrogen storage tank 6 via a second connection to the upper portion of the hydrogen storage tank 6, and a pump 10 positioned at the outlet of the hydrogen storage tank 6. Additionally, the two heaters 2a, 2b are fluidly connected to both the first ejector inlet 4 and the second ejector inlet 5 of both of the two ejectors 3a, 3b, and to a second inlet of the storage tank 6 via the backflow line 17. The flow of hydrogen in these additional fluid paths are controlled by an additional set of valves 8g, 8h 8i, 8j, 8k, 14, which is controlled by a controller 23. The controller 23 communicates with the valves and not illustrated pressure sensors either wirelessly or by wires.

The embodiment of FIG. 3 may thus supply pressurized gaseous hydrogen to a dispenser 21 positioned at a downstream side of the ejectors 3a, 3b, and the dispenser 21 may be utilized for fueling a vehicle tank 22 of the vehicle via either of the two ejectors 3a, 3b, which may be supplied with pressurized hydrogen from either of the two heaters 2a, 2b.

The ejectors of the embodiment of the disclosure illustrated in FIG. 3 are optimized according to one or more ejector performance parameters to operate most efficiently at different ejector inlet pressures and/or mass flow in the ejector inlets. These pressures are so called optimal ejector operational pressures. Thus, in this exemplified embodiment, the first ejector 3a is optimized to pressures at the ejector inlet in the range of 200 bar to 500 bar, while the second ejector 3b is optimized to pressures at the ejector inlet 4 of 500 bar to 800 bar. More specifically, the geometry of the first ejector 3a is optimized based on the mean entrainment ratio performance parameter across a pressure range of 200 bar to 500 bar at the ejector inlet 4, while the geometry of the second ejector 3b optimized according to a mean entrainment ratio performance parameter across a pressure range of 500 bar to 800 bar at its ejector inlet 4.

Other embodiments of the disclosure may have optimized ejectors, wherein specifically the geometry of the ejectors is optimized to different ejector inlet pressure ranges. The ejectors may also be optimized based on other ejector performance parameters, including e.g., compression ratio and/or ejector efficiency. The ejectors may further be optimized based on a combination of ejector performance parameters.

In the example illustrated on FIG. 3, the dispenser 21 is fluidly connected to the vehicle tank 22, and the first heater 2a comprises heated liquid/gaseous hydrogen at a pressure of 800 bar. Ideally, the heater is completely filled with liquid hydrogen at the start of the heating in the heater. However, it should be understood that this is the ideal example case, and therefore completely filled may also refer to e.g., 99% filled, such as 95% filled such as 90% filled, such as e.g., between 80% to 99.9% filled. To refuel the vehicle tank 22, the valve 8k is opened (and 8a is closed) to supply the pressurized hydrogen from the first heater 2a to the first inlet of the second ejector 3b. The second ejector 3b is selected since as described above it is optimized to provide the largest suction pressure at the second ejector inlet of the two ejectors 3a, 3b at the pressure of 800 bar delivered by the first heater 2a in this example.

The hydrogen leaves the first heater 2a as gaseous hydrogen, enters the second ejector 3b and is discharged at the ejector outlet 9 of the second ejector 3b. This causes a suction at the second inlet 5 of the second ejector 3b, and the valves 8j and 8h are opened (8g is closed), to utilize the suction pressure to evacuate e.g., gaseous hydrogen from the second heater 2b. In the second ejector 3b, e.g., gaseous hydrogen from the two ejector inlets 4, 5 is mixed, and at the ejector outlet 9 of the second ejector 3b, the pressure is regained, and the pressurized gaseous hydrogen is supplied to the vehicle tank 22 via the dispenser 21.

As fueling of the vehicle tank 22 continues, the pressure at the ejector inlet 4 of the second ejector 3b gradually decreases. When the pressure falls below the optimal ejector operational pressures of the second ejector 3b of 500 bar, the valves 8k, 8j and 8h is closed, while valve 8a is opened to establish a flow of gaseous hydrogen from the first heater 2a to the ejector inlet 4 of the first ejector 3a. Further, valve 8d is opened to fluidly connect the second inlet 5 of the first ejector 3a to the second heater 2b and thereby allow the evacuation of gaseous hydrogen from the second heater 2b and the fueling of the vehicle tank 22 with the first ejector 3a.

Optionally, the hydrogen refueling station of FIG. 3 may be extended with one or more additional ejectors. These additional ejectors may be optimized to different pressure ranges, wherein each range typically covers a range of 300 bar. This advantageously extends the pressure range (pressures provided by the heaters) within which the hydrogen refueling station is capable of operating optimally.

Optionally, the ejector inlet and/or ejector outlet may be automatically regulated based on a pressure required to fuel a vehicle tank 22 coupled to the dispenser. Thus, if the pressure provided by a heater exceeds the maximum pressure that may be used for fueling a vehicle tank, the pressure may be reduced by reducing the cross-sectional area of the fluid path through the ejector. This may be achieved by limiting the fluid path at the ejector inlet and/or at the ejector outlet. Similarly, the flow through an ejector may be increased by increasing the cross-sectional area of the fluid path through the ejector. In an optional embodiment, the flow and/or pressure regulation may be achieved by using flow regulating valves and/or pressure control valves positioned at the conduit connecting the heater to the ejector and/or by positioning these valves at the conduit connecting the ejector outlet with the dispenser. Adjusting the geometry of an ejector is possible if specific types of adjustable ejectors are selected over fixed geometry ejectors.

In the embodiment illustrated in FIG. 3, the pump 10 pumps liquid hydrogen from the storage tank 6 to the heaters 2a, 2b, which in this exemplified embodiment is evaporators. Notice that other types of heaters may optionally be utilized in this embodiment, and in any embodiment of the disclosure. The pump can be any fluid pump that can comply with the temperature requirements of liquid hydrogen, e.g., a cryopump. The pump may advantageously increase the filling rate of the evaporators and furthermore, in situations where the hydrogen storage tank 6 is positioned below the heaters with respect to the direction of the force of gravity, the pump 10 is required to fill the heaters. Further, in situations where the suction from a second inlet of an ejector may not be available and/or sufficient to fill the heater a pump may also be required. This may e.g., occur if the suction is prioritized for other purposes, e.g., for drawing gaseous hydrogen from the hydrogen storage tank 6 via the backflow line 17 or from optional additional storage tanks comprising gaseous hydrogen (not shown) and e.g., coupled to the backflow line.

The backflow line furthermore makes it possible to return hydrogen, e.g., gaseous hydrogen from one or more heaters and back to the hydrogen storage tank and/or to a second storage tank connected to the backflow line, optionally using a compressor positioned somewhere in the backflow line.

Optionally, a compressor may be positioned downstream to the ejector outlet (not illustrated). This has the effect of increasing the suction pressure that may be created in the second ejector inlet, as well as increasing the pressure difference between the ejector outlet and an evaporator fluidly coupled to the ejector. This pressure difference result in a higher mass flow of hydrogen through the ejector and thereby the compressor may increase the fueling capacity of the hydrogen refueling station, which is advantageous. A further advantage of utilizing a compressor downstream the outlet of one or more ejectors is that it makes it possible to utilize pressures generated by the heating of liquid hydrogen in the heaters of as low as 200 bar. Ones the pressure in a heater reaches this minimum pressure threshold of 200 bar, valves at the outlet of the heater and between the heater and an ejector opens. This enable a flow of hydrogen from the heater to the secondary ejector inlet, and thereby further hydrogen is evacuated from the heater.

Control of the position of valves, prioritizing which heater should be emptied utilizing suction pressures from second ejector inlets, or if suction pressure should be utilized for drawing gaseous hydrogen from the top of the hydrogen storage tank, is controlled by the controller 23. The controller may e.g., be a logic controller, which may also control the required ramp rate target pressure of the system downstream the one or more ejectors, receive input from pressure and temperature sensors, flow sensors, etc. to facilitate required control of e.g., valves, ejectors, pumps, etc. of the hydrogen refueling station. The control may be made based on input from not illustrated pressure and/or temperature sensors. These sensors may be located inside the heater/evaporators, vessels and in the conduit system.

The geometry of ejectors should be tailored to the pressure conditions that occur during operation of the station, in order for them to achieve a good performance. Thus, the geometry of an ejector may optionally be optimized according to the pressures delivered by the one or more heaters that supply pressurized hydrogen to the ejector.

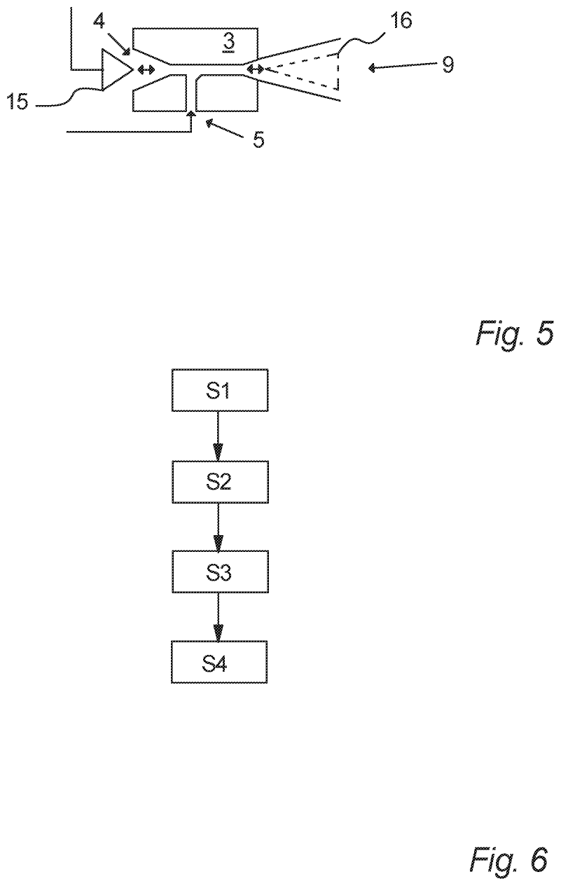

As both pressure delivered from the one or more heaters, and as both the supply pressure, suction pressure and mix pressure in the ejector may vary over time, an ejector at a location can be replaced with an array of ejectors as described below and as shown on FIG. 4, to achieve an improved ejector performance at a broader range of pressure conditions and/or station operation conditions. Optionally, as described below and exemplified on FIG. 5, an ejector with a variable geometry may be implemented to achieve similar effect, which is advantageous.

FIG. 4 shows a schematic illustration of a hydrogen refueling station according to an embodiment of the disclosure. The embodiment illustrated in FIG. 4 extends the embodiment shown in FIG. 3 by including a second storage tank 20 coupled to the backflow line 17 via a compressor 18 and a compressor inlet valve 19, and by further comprising two additional ejectors. Thus, the embodiment comprises an ejector array 13, comprising four ejectors in total, wherein both the ejector inlet and the ejector outlet of any of these ejectors is fluidly connectable to any of the outlets of the heaters 2a, 2b via additional flow paths as exemplified in FIG. 4. The flow of hydrogen in these additional fluid paths are controlled by an additional set of valves arranged in two valve panels 12a-b, which is controlled by a controller (similar to the controller 23).

The ejectors of the array 13 are configured to operate optimally at specific inlet pressures and inlet flows at the ejector inlet (motive flow) and at the second inlet, as well as at the ejector outlet. Since fueling requires pressures at various levels, and since the heaters may be configured to deliver a range of different pressures at the ejector inlet of an ejector, the ejector of a station having only one ejector may not necessarily always operate within its optimum. Furthermore, the fluid path through an ejector with a fixed geometry has a fixed cross-sectional area, and thereby a fixed geometry ejector is not capable of regulating the mass flow streaming through it for given inlet and outlet pressures. Thus, by having a plurality of ejectors with different geometries tailored to operate efficiently at different pressures and/or pressure ranges provide the flexibility to utilize a specific ejector of the ejector array that functions most optimal, given the pressure conditions. Also, the flow of gaseous hydrogen delivered from a heater via an ejector to the downstream side of the ejector array 13 may be regulated by selecting specific ejectors of the ejector array, to achieve a specific flow rate or pressure downstream the ejector array.

In this example, the outlet of the ejector array 13 is connected to one dispenser (not shown). Advantageously, this has the advantage that the mass flow and/or pressure delivered at the dispenser may be regulated by connecting the outlet of a heater to an ejector inlet of a specific ejector, which is configured to provide the required pressure downstream the ejector. As the pressure delivered by the heater fluidly connected to the inlet of the ejector array drops during a fueling operation, the valves of the valve panels 12a-b may advantageously be operated to direct the pressurized gaseous hydrogen from the initially utilized ejector to a different ejector of the ejector array 13 that has a geometry that best matches the current pressure conditions and/or the pressure and/or mass flow requirements downstream the ejector array. This also ensure that the ejector that operates most effectively given the specific pressure conditions may be selected. The selection of ejectors is controlled by a controller (similar to controller 23 of FIGS. 1 and 3), which may receive input from sensors of the station and/or vehicle. Sensors may include e.g. pressure, flow and temperature sensors.

Optionally, a hydrogen station according to the disclosure may be expanded with additional ejectors/ejector arrays that may each be fluidly couplable to further dispensers (here a dispenser is defined at least by a hose and a nozzle).

Advantageously, this enables the hydrogen refueling station to fuel a plurality of vehicle tanks simultaneously. E.g., the ejector outlet of all four ejectors of the ejector array 13 illustrated in FIG. 4 could be couplable to e.g., any of e.g., three dispensers. Advantageously, this has the effect that ejectors may be utilized to fill a plurality of vehicle tanks simultaneously, e.g., three vehicle tanks. The selection of which ejector that is utilized in a given fueling situation may further as previously explained be based on the pressure at the ejector inlet and/or other pressures such as pressure downstream the ejector and/or at the second ejector inlet. Having four ejectors, the first ejector may be optimized to work efficiently at lower inlet pressures from e.g., 200-500 bar, the second ejector at medium inlet pressures e.g., from 500-900 bar, the third ejector at higher inlet pressures e.g., from 900-1400 bar, and the fourth ejector at even higher pressures e.g., from 1400-2000 bar. As an example, a vehicle tank having a low tank pressure may initially utilize the fourth ejector as the inlet pressure to the ejector is high at the start of the fueling operation where in this example the heater provides a pressure of 2000 bar, subsequently as the vehicle tank pressure increases and the inlet pressure to the ejector decreases during the fueling, ejector three is utilized for fueling this vehicle tank when the inlet pressure falls below 1400 bar etc. Meanwhile, a second vehicle tank may start fueling utilizing a different ejector and again this ejector s selected utilizing based on the ejector inlet pressure that is delivered by the heater. Multiple ejectors optimized to the same inlet pressure ranges may be implemented, to provide the flexibility of utilizing e.g., two ejectors optimized to the same ejector inlet pressure ranges when two vehicles are simultaneously fueled. Thus, advantageously, in an implementation of the disclosure, an ejector array may be provided per dispenser of the hydrogen refueling station.

FIG. 5 illustrates the principles of an ejector usable in the present disclosure. This ejector comprises a first inlet 4 and a second inlet 5 both fluidly connected to a mixing chamber inside the ejector. The mixing chamber is fluidly connected to a constant part of the ejector, which again is fluidly connected to an ejector outlet 9 comprising a diffuser, and configured for discharging fluid such as e.g., hydrogen, and in particular gaseous hydrogen. Entering the ejector inlet 4 the pressurized hydrogen gas from the first and/or the second heater is accelerated, thereby decreasing pressure and temperature of the hydrogen gas. The accelerated hydrogen gas creates a suction effect (suction pressure) in the second ejector inlet 5 and thereby the low-pressure may be utilized to evacuate hydrogen gas from one or more heaters 2a, 2b and/or subsequently for filling one or more heaters with hydrogen from the hydrogen storage 6. Optionally, the suction effect created at the second inlet can also be used to draw gaseous hydrogen 11 via a fluid connection to the upper portion of the hydrogen storage tank 6.

Irrespective of its origin, the hydrogen drawn into the ejector 3 by the suction effect via the second ejector inlet 5 is mixed with the motive fluid entering the ejector 3 via the first ejector inlet 4. In this example the motive fluid is hydrogen pressurized by at least one of the plurality of heaters 2a, 2b. The mixing is made in the mixing chamber and constant parts of the ejector. The diffuser is used to recover the pressure.

The upper part of the storage tank 6 will typically always comprise some hydrogen in the liquid state. This may be due to the temperature increase that is happening at lease if no cooling is provided to the storage tank 6. This gaseous hydrogen may also be a source of suction of a second inlet from the ejectors.

The ejector outlet 9 may comprise a geometry regulator 16 (indicated by dotted lines), and a first ejector inlet regulator 15. Both the geometry regulator 16 and the first ejector inlet regulator 15 may be regulated by a controller. The effect of such geometry regulator 16 is that the geometry of the ejector outlet 9, e.g., the diffuser part of the ejector 3, can be adapted to different flow and pressure relationships. The velocity of hydrogen flow can be regulated and when the velocity is reduced, the pressure is increased, hence, the control of the geometry regulator 16 may be considered a control parameter for regulating pressure of hydrogen to the downstream side of the ejector 3, which may comprise one or more hydrogen dispensers and/or one or more hydrogen storage tanks. The regulators 15, 16 may be controlled by a controller such as the controller 23 illustrated on FIGS. 3 and 1 based on input from sensors such as e.g., flow, pressure, and temperature sensors.

Optionally, the geometry of various parts and/or portions of the ejector 3 may be variable, and thereby the ejector can be considered a variable and/or semi-variable ejector. All or some of the variable parts and/or portions of the ejector may be controlled by a controller, thereby advantageously achieving the effect of e.g., being able to adapt to different flow and pressure relationships and requirements downstream and/or upstream the ejector. Thus, the ejector may optionally comprise one/or more of the following variable parts and/or portions: an adjustable throat, an adjustable laval orifice, an adjustable aerospike, an adjustable transonic diffuser, an adjustable subsonic diffuser.

A variable or semi-variable ejector could from adjustments of the mentioned variable parts and/or portions by actuators, e.g., controlled by a controller, e.g., based on measurements of the various pressures in the first ejector inlet and/or the second ejector inlet and/or the ejector outlet, accommodate the geometry to be optimal according to any operational state of the hydrogen refueling station. This control may further be based on sensor inputs from sensors including e.g., flow sensors, pressure sensors, temperature sensors. Operational state may here refer to a state where the hydrogen refueling station is in a standard operation mode e.g., fueling one or more vehicles, to a state of high utility of the station, to a low utility state where the station is not fueling vehicles etc. and also to further operational states associated with e.g., service of the station etc.

Different variable geometries of an ejector that is adjustable in different ways have been described an illustrated in relation to FIG. 5. For simplicity, not all possible variations of variable ejectors are illustrated. Nevertheless, according to the disclosure, these different variants of variable ejectors may certainly be combined into a variable ejector comprising any one, two, three or all of the mentioned features associated with adjustability of an ejector. Thus, a variable ejector according to the disclosure may comprise any one or more of the features of an adjusting throat, adjustable laval orifice, adjustable aerospike, adjustable transonic diffuser, adjustable subsonic diffuser.

A variable ejector may be capable of variating various parameters of the ejector, including ejector geometry, including e.g., the size and/or shape of: the motional center, of the subsonic diffuser, of the laval orifice, of the aerospike, of the transonic diffuser, ejector throat, etc.

Semi-variable ejectors may comprise ejectors with one variable parameter, e.g., the ‘motional center’, whereas other parameters of the ejector are fixed and thereby not adjustable. Semi-variable ejectors with different fixed parameters may advantageously be combined in an array of ejectors to achieve flexibility with regards to the mass flow of hydrogen that may be supplied downstream the ejector array, with regards to the different suction pressures that may be achieved in the second ejector inlets of the various different ejectors, and also flexibility with regards to the pressure downstream to the array of ejectors.

The disclosure may be implemented using one variable ejector. However, as described above, and in particular in relation to the embodiments shown in FIG. 3 and FIG. 4, it may be advantageous to implement two ejectors and even an array of ejectors. Such implementations may advantageously comprise one or more variable ejectors. Advantageously, this has the effect of providing further flexibility with regards to regulating the ejector array and/or the two-ejector setup to different flow and pressure relationships and requirements downstream and/or upstream the ejector array or the two-ejector setup. A further advantage of having more than one variable and/or semi-variable ejector is that a dispenser may be supplied separately from one of these ejectors. Thereby a fueling operation may always be carried out with a dispenser that is optimized according to the pressure delivered from a heater and the vehicle tank pressure. Also, having one or more variable ejectors may have the further advantage of providing a more stepless regulation of flow.

To make the hydrogen refueling station, according to an embodiment, able to perform a refueling, liquid hydrogen is feed from the storage 6 to the heater 2a. The volume of the liquid hydrogen is isolated in the heater or at least between the valves 8e and 8a/8b. In this way a pressure is generated in the heater by volume constrained heating of the liquid hydrogen. The initial step S1 illustrated on FIG. 6 in the refueling may be referred to as “ready”.

A user may then activate the controller 23, connect the nozzle to the vehicle and initiate refueling e.g., be payment and activating a start button. This step S2, may be referred to as “pre-refueling”.

Once started, the flow of hydrogen is initiated by opening valve 8a and 8d. The excess pressure in the heater 2a is then utilized through the ejector 3 to provide a suction on the ejector's 3 secondary inlet 5. This suction is then used to evacuate the residual hydrogen gas in the neighboring heater 2b trough valve 8d. This step S3, may be referred to as “refueling”.

Once the dry neighboring heater 2b is evacuated from hydrogen gas to a pressure that will allow transfer of liquid hydrogen from the liquid storage 6 to the heater 2b, the suction from the ejector 3 is maintained to the heater 2b to fill the heater 2b with liquid hydrogen. If there are too much hydrogen gas in the first heater 2a, this may be led to a buffer storage or to the top of the storage 6. The gaseous hydrogen in the storage 6, may later, if a compressor is present, be compressed and use for fueling a receive vessel. This procedure is continued with suction priority to the dry heater with least pressure, or to the vapor side of the liquid storage. This step S4, may be referred to as “filling heater”.

Typically, the pressure in the heater 2a is sufficient to complete a refueling of a vehicle tank 22. If this, however, is not the case and when the heater 2b is filled with liquid hydrogen, the vehicle tank 22 is not full. Then the process is repeated just this time with the primary flow from heater 2b and suction from heater 2a.

It should be mentioned, that due to the possible high pressure in the heaters 2a, 2b direct fueling from one of these heaters may be possible. Also, it should be mentioned, that if pressure has been established in buffer tanks, then fueling with a buffer tank as source may also be possible. The latter can be possible either directly, via an ejector as described above or via a compressor. Thus, the suction created in a second ejector inlet of an ejector may optionally be utilized to draw hydrogen, e.g. gaseous hydrogen, form a buffer tank, and utilize it for fueling via the ejector outlet. This is achieved by coupling the second ejector inlet to the buffer tank via valves. A controller may control this operation. This is advantageous, in that it provides efficient fueling of a vessel, e.g., in situations where other heaters may not provide hydrogen for fueling via a second ejector inlet, e.g. due to such other heater being empty because hydrogen has already evacuated from the heater.

When filling a receiving vessel such as a tank of a fuel cell vehicle, the pressure increase in the receiving vessel is typically controlled to follow a so-called ramp rate within an upper and a lower limit. Following the target ramp rate pressure is done by the controller in dependency of the number and types of ejectors. It is obvious, that with only one ejector with fixed geometry, this control can't be as precise as if several fixed geometry ejectors or variable geometry ejectors are at disposal. If only one ejector is available, preferably it is of a variable type, to be able to regulate the capacity/pressure.

The controller 23 is adjusting the geometry of the ejector based on input from e.g., pressure sensors downstream the ejector, pressure sensors providing information of pressure in the primary (connected to first inlet) and secondary (connected to second inlet) heaters. The higher pressure in the primary heater and the lower ramp rate target pressure, the more gaseous hydrogen can be sucked from the secondary heater. If these pressures decrease, increase respectively, then to maintain ramp rate target pressure suction from the secondary heater may be reduced. Alternatively, the primary pressure i.e., from the primary heater into the ejector may be increased.

If necessary, the ejector can act as a pressure regulating valve and thereby control pressure from the primary heater out of the ejectors to follow the ramp rate target pressure. If the primary pressure becomes close to the ramp rate target pressure, the controller 23 will change primary source i.e., control valves so that another heater preferably at its heater target pressure becomes primary heater and the former primary heater is secondary to be able to empty it for gaseous hydrogen and fill it with liquid hydrogen again.

In the following the thermal control/management system will be described. The main task of the heaters are continuous heating and cooling of the hydrogen comprised therein. Since a significant pressure is established, the heaters would contain a sufficient mass of tank/tube wall to contain the pressure.

When a batch of hydrogen is evaporated from the heater and pressure is reduced by means of ejectors to allow for a new charge of liquid hydrogen at around minus 253 degrees Celsius, the mass of tank and/or tube is considerably warmer-up to around 250 K warmer and in principle as warm as the ambient temperature. This temperature difference would cause a large amount of hydrogen to boil off immediately, when liquid hydrogen is introduced, thus preventing the pressure of the closed evaporator to reach a preferred level, or causing an undesired pressure-increase in the liquid storage.

To counteract this, the thermal management system is introduced. In an embodiment, this system connects the heaters containing hydrogen in the phase of warming up, by circulating a coolant from the warmest heater to provide cooling for the heater to be filled, ending at the coldest heater in the warm-up faze supplying cooling to the heater to be filled. Thereby the heater to be filled, is cooled to provide less boil off, of the liquid hydrogen when filled into the heater. Suitable cooling medias to be circulated in the thermal management system comprising conduits connecting the heaters are e.g., helium, hydrogen, neon, or nitrogen. Preferably, the cooling media should be heated from ambient by an expanded surface before introduced to the warmest evaporator. Note, that cooling media and cooling system should also preferably be able to heat up a heater.

When no filling of heaters is due, the heaters may be connected in series, where the warmest evaporator is providing heating for the second warmest and so forth. Thereby by heat transfer from the warmest of two heaters to a colder heater, the warmest heater is cooled, and the coldest heater is heated. In some embodiments of the disclosure, this principle may advantageously be utilized to heat hydrogen in the coldest heater with heat transferred from a warmer heater from which hydrogen has already been heated and evacuated.

In each of the above-described embodiments, the heaters may produce pressure up to 1500 to 2500 Bar, dependent on the level of liquid hydrogen that is filled into the heaters and the available end temperature (the higher available temperature, the higher pressure allowed). If suction of ejectors is inadequate to keep the pressure of the liquid storage in a particular heater down or a heater is empty so that no hydrogen can be evacuated, the discharge pressure of the ejectors can be reduced by introducing a high-pressure compressor downstream the ejectors and thereby improve the ejectors suction capability. Such compressor is preferably connected to a high-pressure storage to provide flow of hydrogen to a fueling vehicle if evaporation and heating of evaporators is slow.

Furthermore, a small compressor capable of compressing boil off from the liquid storage of the heater may be introduced to ensure evacuation of boil off during periods of low utilization i.e., in periods where no refueling is made.

The disclosure has been exemplified above with the purpose of illustration rather than limitation with reference to specific examples of methods and embodiments.

Notice that according to the disclosure, any one or more of the above-described embodiments of the disclosure may be combined. E.g., the embodiment of FIG. 4 comprising an array of ejectors and two heaters, may be combined with the variable ejector described in relation to FIG. 5. Also, in large refueling stations comprising a plurality of dispensers, the refueling capacity of the hydrogen refueling station may be increased by adding additional heaters and ejectors, which may provide additional supply of pressurized gaseous hydrogen based on a supply of liquid hydrogen to the heaters and a supply of gaseous hydrogen from the heater to the ejectors. E.g., a hydrogen refueling station may optionally comprise an ejector and/or an ejector array for each dispenser. Also, the non-illustrated elements may be combined with the different illustrated and non-illustrated embodiments.

Optionally, the hydrogen refueling station may comprise an array of heaters. The heaters may be configured to provide gaseous hydrogen to one or more downstream ejectors at different levels of pressures. Thus, the fueling mass flow rate and/or fueling pressure may be controlled based on selecting which of the heaters that provides pressurized hydrogen for the fueling. E.g., the heater having the lowest pressure that may achieve a sufficient fueling ramp rate may be utilized first, and as the tank pressure in the vehicle tank to be fueled increases, a heater delivering a higher pressure is selected. If required, a third heater providing even more pressure may be selected and so forth. This is advantageous in that it has the effect of saving the heaters having the highest pressurized hydrogen for the stages of fueling that requires the highest pressure, while utilizing the lower pressures in some heaters at the fueling stages where the vehicle tank pressure is low.

Note that the output of one or more ejectors may be connected to one or more dispensers i.e., may be used simultaneously or individually to fuel a receiving vessel such as a vehicle tank.

In an optional implementation of the disclosure, two or more ejectors may be utilized simultaneously in parallel. The two or more ejectors may be supplied with hydrogen by the same heater, and thereby one heater may be utilized to supply pressurized hydrogen to a plurality of dispensers via the plurality of ejectors.

Optionally, one or more ejectors may be utilized for fueling while one or more other ejectors are utilized for supplying pressurized gaseous hydrogen to a buffer tank positioned downstream the ejector. Advantageously, the hydrogen refueling station may thus be configured with a plurality of ejectors and a plurality of heaters connected to said ejectors and thereby the hydrogen refueling station may be capable of filling one or more buffer tanks with gaseous hydrogen, while at the same time fueling one or more vehicle tanks of one or more vehicles, based on a supply of liquid hydrogen to the heaters.

The priority of suction and control of valves is controlled by a controller such as the controller 23 illustrated in FIGS. 1 and 3, and at least partly based on sensor inputs, e.g., from sensors such as flow sensors, temperature sensors, pressure sensors. The controller 23 may e.g., be a programmable logic controller (PLC) or any other types of industrial controllers/computers, which may e.g., control the heater target pressure, the required ramp rate target pressure of the system downstream the ejector and others in the hydrogen refueling station. Other types of controllers and more than one controller may be applied depending on the specific implementation of the disclosure.

In further optional embodiments of the disclosure, the hydrogen refueling station comprises a compressor fluidly connected to a hydrogen buffer tank. This is advantageous in that e.g., gaseous hydrogen may be evacuated from e.g., one or more heaters to be stored in the hydrogen buffer tank. The gaseous hydrogen stored in the buffer tank can then advantageously be utilized for fueling one or more vehicles.

In another optional embodiment of the disclosure, the hydrogen refueling station comprises a compressor fluidly connected to the hydrogen storage tank. In an optional embodiment of the disclosure, the compressor may be configured to lower the pressure in the hydrogen storage tank, e.g., by removing gaseous hydrogen from the storage tank. Advantageously, this has the effect that the temperature in the hydrogen storage tank may be reduced by removing gaseous hydrogen from the upper portion of the hydrogen storage tank via an outlet positioned at the top end of the hydrogen storage tank, using the compressor. In particular, removing the gaseous hydrogen from the hydrogen storage tank lowers the pressure in the tank, causing the liquid hydrogen inside the hydrogen storage tank to boil and thereby the temperature of the hydrogen in the tank is reduced due to the energy required for the boiling. This may be particularly useful when the heaters and ejectors is not active and therefore the suction pressure provided by ejectors cannot be utilized for this. This may occur e.g., during low utility periods where the station is not fueling many vehicles.

1. A hydrogen refueling station comprising:
a plurality of heaters;
at least one ejector comprising a first ejector inlet, a second ejector inlet, and an ejector outlet;
a hydrogen storage tank fluidly connectable to said first ejector inlet and said second ejector inlet via said plurality of heaters, and configured to store liquid hydrogen;
valves configured to control a flow of said liquid hydrogen in conduits between said hydrogen storage tank and said plurality of heaters and gaseous hydrogen in conduits between said plurality of heaters and said at least one ejector; and
wherein said at least one ejector is configured to receive gaseous hydrogen from at least a first of said plurality of heaters via said first ejector inlet and to simultaneously evacuate gaseous hydrogen from at least a second heater of said plurality of heaters via said second ejector inlet.

2. The hydrogen refueling station according to claim 1, wherein said plurality of heaters are configured to isochoric heating of liquid hydrogen.

3. The hydrogen refueling station according to claim 1, wherein at least one heater of said plurality of heaters are configured to heat said hydrogen based on heat transfer from a surrounding of said at least one heater to said heater.

4.-5. (canceled)

6. The hydrogen refueling station according to claim 1, wherein the hydrogen refueling station comprises a temperature management system, comprising a controller and a temperature sensor.

7. The hydrogen refueling station according to claim 6, wherein said temperature management system further comprises conduits thermally connecting said plurality of heaters enabling transfer of heat among said plurality of heaters.

8.-9. (canceled)

10. The hydrogen refueling station according to claim 6, wherein the temperature management system is configured for cooling one of said plurality of heaters before said one heater is filled with liquid hydrogen.

11. The hydrogen refueling station according to claim 1, wherein said one heater is cooled to a predefined temperature before liquid hydrogen is allowed to enter said one heater.

12.-13. (canceled)

14. The hydrogen refueling station according to claim 1, wherein said hydrogen refueling station comprises an array of ejectors.

15. The hydrogen refueling station according to claim 148, wherein the ejectors of said array of ejectors have a different internal geometry.

16. The hydrogen refueling station according to claim 1, wherein said at least one ejector has variable internal geometry.

17.-19. (canceled)

20. The hydrogen refueling station according to claim 1, wherein said second ejector inlet of said at least one ejector is connectable to an upper inlet of said hydrogen storage tank.

21. The hydrogen refueling station according to claim 1, wherein the hydrogen refueling station comprises a compressor fluidly connected to a hydrogen buffer tank and/or comprises a compressor fluidly connected to the hydrogen storage tank and/or comprises a compressor fluidly connected to at least one ejector outlet of said plurality of ejectors.

22. The hydrogen refueling station according to claim 1, wherein gaseous hydrogen received at said first ejector inlet of said at least one ejector and gaseous hydrogen received at said second ejector inlet of said at least one ejector is provided to a receiving vessel of a vehicle connected to a dispenser of said hydrogen refueling station via said ejector outlet of said ejector.

23. A method of filling a receiving vessel with hydrogen gas, said method comprises the steps of:
establishing a flow of liquid hydrogen from a storage tank to a first heater, receiving said liquid hydrogen in a fixed volume;
increase pressure in said first heater by establish a phase shift from liquid hydrogen to gaseous hydrogen in said first heater;
decrease pressure in said first heater by allowing hydrogen in gaseous state to flow from said first heater to a first inlet of an ejector;
allow flow of gaseous hydrogen from a hydrogen supply to a second inlet of said ejector, wherein said flow is created by the flow of gaseous hydrogen entering said first inlet; and
guide said flow of gaseous hydrogen, mixed from said first and second inlets of said ejector, from an outlet of said ejector to a receiving vessel.

24. The method of filling a receiving vessel with hydrogen gas according to claim 23, wherein said method further comprises the step of terminating flow from said outlet when a target pressure in the receiving vessel is reached.

25. The method of filling a receiving vessel with hydrogen gas according to claim 23, wherein said method further comprises the step of controlling pressure out of ejector by adjusting the geometry of the ejector.

26. (canceled)

27. The method according to claim 23, wherein said method further comprises the steps of:
establishing a flow of liquid hydrogen from a storage tank to a second heater, receiving said liquid hydrogen in a fixed volume of said second heater;
terminating said flow from said first heater to said first inlet of said ejector, when a fueling pressure drops below a predefined threshold;
increase a pressure in a second heater by heating said liquid hydrogen received in a fixed volume of said second heater by said second heater;
decrease pressure in said second heater by allowing hydrogen in gaseous state to flow from said second heater to said first inlet of said ejector;
evacuate gaseous hydrogen from said first heater by establishing a flow of hydrogen from an outlet of said first heater to said second inlet of said ejector, wherein said flow is established by said flow of gaseous hydrogen from said second heater to said first inlet of said ejector; and
guide said flow of gaseous hydrogen, mixed from said first and second inlets of said ejector, from an outlet of said ejector to a receiving vessel.

28.-30. (canceled)

31. The method of filling a receiving vessel with hydrogen gas according to claim 23, wherein the method further comprises the step of pre-cooling of said first and/or second heaters.

32.-34. (canceled)

35. The method of filling a receiving vessel with hydrogen gas according to claim 23, wherein said receiving vessel is supplied with gaseous hydrogen from a heater, of a plurality of heaters, having the lowest usable fueling pressure.

36. A hydrogen refueling station comprising:
a plurality of heaters;
at least one ejector comprising a first ejector inlet, a second ejector inlet, and an ejector outlet;
a hydrogen storage tank fluidly connectable to said first ejector inlet and said second ejector inlet via said plurality of heaters, and configured to store liquid hydrogen;
valves configured to control a flow of said liquid hydrogen in conduits between said hydrogen storage tank and said plurality of heaters and gaseous hydrogen in conduits between said plurality of heaters and said at least one ejector; and
wherein said at least one ejector is configured to receive gaseous hydrogen from at least a first of said plurality of heaters via said first ejector inlet and to simultaneously evacuate gaseous hydrogen from at least a second heater of said plurality of heaters via said second ejector inlet; and
wherein the hydrogen refueling station is operated according to the method of claim 23.
